(19) United States
(12) Patent Application Publication
(10) Pub. No.: US 2011/0213298 A1
(43) Pub. Date: Sep. 1, 2011

(54) MEDICINAL DOSING APPARATUS

(75) Inventor: Michael D. Pinnisi, Ithaca, NY (US)

(73) Assignee: Cognitive Science LLC, Ithaca, NY (US)

(21) Appl. No.: 12/982,454

(22) Filed: Dec. 30, 2010

Related U.S. Application Data
(60) Provisional application No. 61/291,678, filed on Dec. 31, 2009.

(51) Int. Cl. A61J 7/00; B23P 17/04; B29C 65/70

(52) U.S. Cl. 604/77; 29/428; 156/242

(57) ABSTRACT

A method ensuring accurate oral dosage of a liquid medication includes providing an oral dosing apparatus with a medication, the volume of the oral dosing apparatus accurately sized to provide an effective oral dose of medication, and instructing a user to fill the oral dosing apparatus with the medication for dispensation, the oral dosing apparatus including a visual indicator regarding the amount to fill.

### TECHNICAL FIELD

This disclosure is generally related to accurate dosing of oral medicines.

### BACKGROUND

Spoon dosing has been identified as a major cause of dosing errors and pediatric poisonings. Although the FDA recommends against using standard silverware to dose liquid medicine, many people continue to use spoons when orally dosing medication. While dosing errors may be modest when using teaspoons, they can increase when using various sizes of larger spoons. If, in one example, five milliliters of liquid medicine (e.g., approximately a teaspoon) appears as markedly less than a teaspoon on a larger spoon, a person may compensate and overdose.

### SUMMARY

A method ensuring accurate oral dosage of a liquid medication includes providing an oral dosing apparatus with an medication, the volume of the oral dosing apparatus accurately sized to provide an effective dose of medication, and instructing a user to fill the oral dosing apparatus with the medication for dispensation, the oral dosing apparatus including a visual indicator regarding the amount to fill.

In some implementations, the oral dosing apparatus includes a well area composed of a first material, the volume of the well area sized to contain the effective dose of the medication and a rim area composed of a second material, the first material being visually distinctive from the second material. In other implementations, the oral dosing apparatus includes a visually distinctive fill line, and the patient is instructed to fill the oral dosing apparatus to the fill line.

A medicinal oral dosing apparatus includes a well area composed of a first material, a volume of the well area sized to accept an effective oral dose of medicine, and a rim area composed of a second material, the second material being visually distinctive from the first material, wherein the distinction between the well area and the rim area provides a visual indicator to a patient regarding the amount of medicine to fill.

In some implementations, the first material or the second material has luminescent qualities, the well area includes a first and second color and the rim area includes a third color, the first and second colors being visually distinctive from the third color and a volume of the well area being marked by the second color sized to contain a dose of medication smaller than the effective dose of medication marked by the first color. The apparatus can include a visually distinctive fill line as the visual indicator, wherein a color of the fill line is visually distinctive from the color of the medication. The apparatus can include a second fill line corresponding to a child dose. The fill line can include luminescent qualities. The apparatus can be one of a spoon or cup. The method can further include providing a second oral dosing apparatus with the medication, a second volume of the second oral dosing apparatus accurately sized to provide a second dose of medication, the second dose being effective to a category of patient, the effective second dose being different from the effective dose, and

instructing the patient to fill the second oral dosing apparatus with the medication for dispensation to the category of patient, the second oral dosing apparatus including an indication regarding the category of patient. The category of patient can include one of an age range or a weight range.

A method of manufacturing a medical dispensing apparatus includes attaching an oral dosing apparatus comprising a well area composed of a first material and a rim area composed of a second material distinctive from the first material to an apparatus containing a medicine.

In some implementations, the oral dosing apparatus is attached to the apparatus containing the medicine by molding the oral dosing apparatus with a cap attachable to the apparatus containing the medicine.

### DESCRIPTION OF DRAWINGS

FIG. 1 illustrates a comparison of spoon sizes and estimated oral dosages of medication.

FIG. 2A is a top view of an exemplary medicinal dosing apparatus including a visual fill line.

FIG. 2B is a top view of an exemplary medicinal dosing apparatus including a well composed of material visually distinctive from the surrounding material.

FIG. 2C is a top view of an exemplary medicinal dosing apparatus including a well composed of two visually distinctive regions, the regions corresponding to two different dosages.

### DETAILED DESCRIPTION

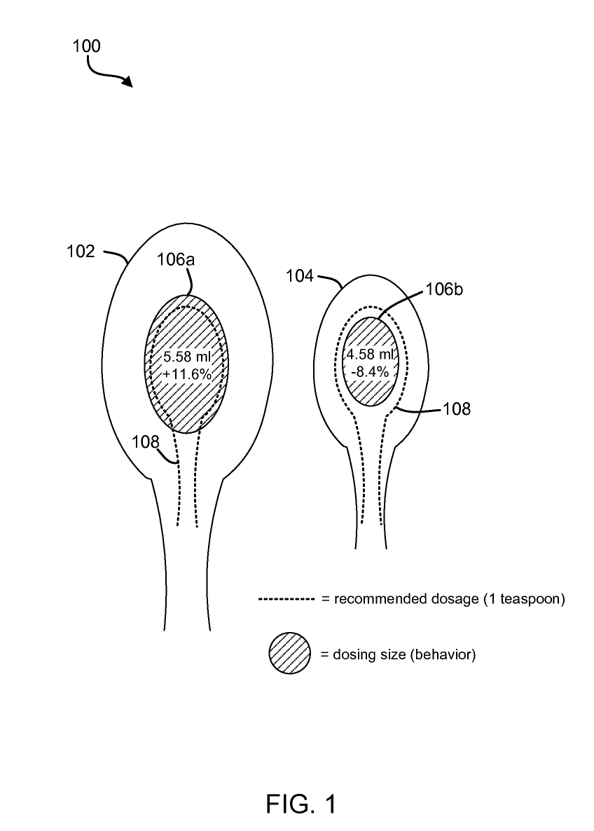

FIG. 1 illustrates a comparison of spoon sizes and estimated oral dosages of medication. According to Spoons Systematically Bias Dosing of Liquid Medicine by Brian Wansink and Koert Van Ittersum, July 2009, which is incorporated herein by reference in its entirety, university students were asked to dose 5 mL of cold medicine into a teaspoon (5 mL, 2.7×4 cm), a medium-sized (table)spoon (15 mL, 4×6 cm), and a larger spoon (45 mL, 6×9 cm). After correctly dosing into a teaspoon, the students were asked to “eyeball” the same volume into the medium-sized and larger spoons.

Upon measurement, it was determined that the amount of cold medicine the students poured varied directly with the size of the spoon used. As illustrated in FIG. 1, on average, the students poured a dosage 106a of approximately 8.4% less than a teaspoon 108 into a medium-sized spoon 102 and a dosage 106b of approximately 11.6% more than a teaspoon 108 into a large spoon 104. The students had above average confidence that they were accurate in their pouring and they believed that the dosages they had poured into both spoons would be equally effective.

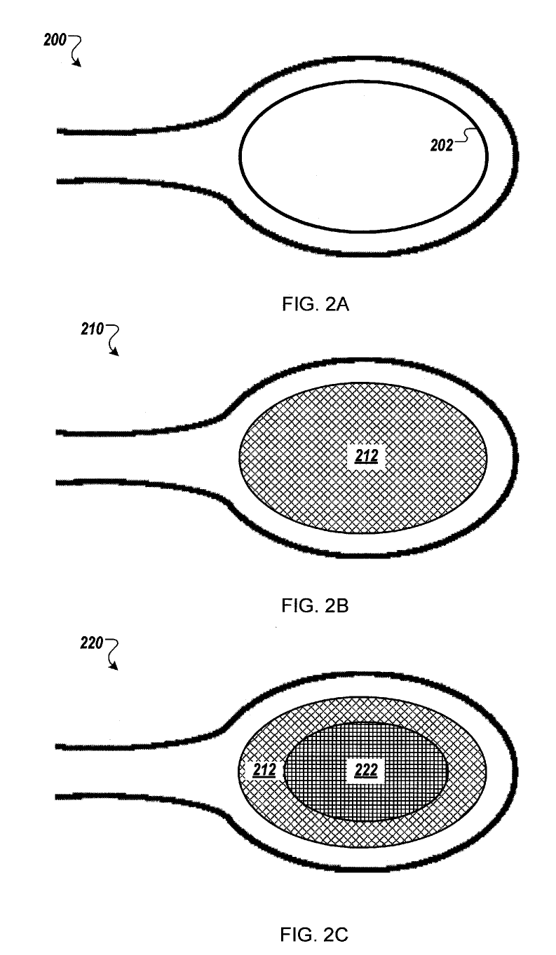

As shown in FIGS. 2A through 2C, various implementations of medicinal dosing spoons include visual indicators designed to increase the accuracy of a patient's dosing of oral medicine. Although the implementations have been illustrated in the form of a dosing spoon, in other implementations, a cup, vial, or other container appropriately sized and shaped for sipping or drinking a dosage of oral medicine can be used.

FIG. 2A illustrates an exemplary medicinal dosing spoon 200 including a visual fill line 202. The visual fill line, in some examples, can include a pattern that is molded or carved within the material of the dosing spoon 200, a thick band of color which vividly contrasts with the color of the dosing spoon 200, or a luminescent band such as a glow-in-the-dark material or an electric light. The user, for example, can be instructed to fill the dosing spoon 200 to the visual fill line 202 to receive an effective dosage of medicine.

FIG. 2B illustrates an exemplary medicinal dosing spoon 210 including a well 212 composed of a material that is visually distinctive from the surrounding material of the spoon 210. The well 212, in some examples, can include a pattern that is molded or carved within the material of the dosing spoon 200, an area of color which vividly contrasts with the color surrounding the well 212, or a luminescent area such as a glow-in-the-dark material or an electric light. Conversely, the luminescent area or patterned area can correspond with the material surrounding the well 212 (e.g., the rim of the dosing spoon 200). The user, for example, can be instructed to fill the dosing spoon 210 until covering the area of the well 212 with the medicine to receive an effective dosage of medicine.

FIG. 2C illustrates another implementation of a medicinal dosing spoon 220 that includes a well composed of two visually distinctive regions 212, 222, the regions 212, 222 corresponding to two different dosages. A first region 222, for example, can correspond to the dosage for a child, while the second region 212 can correspond to the dosage for an adult. As described in relation to the dosing spoon 210 of FIG. 2B, the first region 222 and the second region 212 can differ in patterning, material, or color. In other implementations, as described in relation to FIG. 2A, a set of visual fill lines can correspond to the first dosage volume, and the second dosage volume. In some implementations, the first region 222 can be marked with an indication regarding “Child”, an age range, a weight range, or other textual indication of the appropriate patient corresponding to the smaller dosage. Similarly, the second region 212 can also be marked with “Adult”, a weight range, or other textual indication of the appropriate patient corresponding to the larger dosage.

In each of above examples, the medicinal dosing spoons 200, 210, 220 can be proportioned such that the total volume of the dosing spoons 200, 210, 220 is substantially close to the intended dosage of medicine. For example, the outer perimeter of the dosing spoon may be negligible in respect to the volume of the well of the dosing spoon, disallowing the user of the spoon to significantly overdose the medication. Similarly, the visual fill line can be positioned substantially close to the rim of the oral dosing apparatus to discourage the consumption of a significant overdose of medication.

To further encourage proper dosing, in some implementations, separate medicinal dosing spoons can be provided for different dosage requirements. For example, an adult dosing spoon and a child dosing spoon can both be provided with orally dosed medication, each dosing spoon clearly indicating the intended user or category of user (e.g., child versus adult, age range, weight range, etc.) in a graphical and/or textual manner. In these implementations, the effective dose for the adult is different than the effective dose for the child and so the size of the device provided for the adult is adjusted to better match the dose for the adult as compared to the child.

The medicinal dosing spoons of the above-discussed implementations may be manufactured as part of or attached to a medicine bottle or other device holding the medicine to be dispensed by the user. For example, the medicinal dosing spoons 200, 210, 220 may be molded with or otherwise attached to a medicine bottle cap such that the user is required to handle the dosing spoon when opening the bottle. This will encourage the user to actually use the dosing spoon when dispensing the medicine, thereby helping to prevent over or under dosing of the medicine. Other known means of attaching the spoon to the medicine cap or bottle can be employed, such as, attaching the spoon to the bottle using a plastic clip, snap fit, or other know attachment methods.

While this description contains many specifics, these should not be construed as limitations on the scope of what is being claimed or of what may be claimed, but rather as descriptions of features specific to particular implementations. Certain features that are described in this description in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Thus, particular implementations have been described. Other implementations are within the scope of the following claims.

1-12. (canceled)

13. A method comprising:
providing an oral dosing apparatus with a medication, a volume of the oral dosing apparatus accurately sized to provide effective dose of medication; and
instructing a patient to fill the oral dosing apparatus with the medication for dispensation, the oral dosing apparatus including a visual indicator regarding the amount to fill.

14. The method of claim 13, wherein the category of patient includes one of an age range or a weight range.

15-22. (canceled)

23. A method of manufacturing a medical dispensing apparatus, comprising:
attaching an oral dosing apparatus comprising a well area composed of a first material and a rim area composed of a second material distinctive from the first material to an apparatus containing a medicine.

24. The method of claim 23, wherein the oral dosing apparatus is attached to the apparatus containing the medicine by molding the oral dosing apparatus with a cap attachable to the apparatus containing the medicine.
